(19) United States
(12) Patent Application Publication
(10) Pub. No.: US 2021/0382438 A1
(43) Pub. Date: Dec. 9, 2021

(54) Watch Component And Watch

(71) Applicant: Seiko Epson Corporation, Tokyo (JP)

(72) Inventor: Daiki FURUSATO, Ina (JP)

(21) Appl. No.: 17/336,358

(22) Filed: Jun. 2, 2021

(30) Foreign Application Priority Data
Jun. 3, 2020 (JP) 2020-096687

(51) Int. Cl. G04B 37/22

(52) U.S. Cl. CPC G04B 37/22

(57) ABSTRACT

Included is austenitized ferritic stainless steel including a base composed of a ferrite phase, a surface layer composed of an austenitized phase, and a mixed layer formed between the base and the surface layer, the ferrite phase and the austenitized phase being mixed with each other, wherein the surface layer includes a mirror surface and a streak, and Sa_m/Sa is 0.01 to 0.2 and Sa/Sz is 0.03 to 0.1, where average roughness of the mirror surface is Sa_m, average roughness of the streak is Sa, and maximum roughness is Sz.

The present application is based on, and claims priority from JP Application Serial Number 2020-096687, filed Jun. 3, 2020, the disclosure of which is hereby incorporated by reference herein in its entirety.

### BACKGROUND

### 1. Technical Field

The present disclosure relates to a watch component and a watch.

### 2. Related Art

Stainless steel is widely used for a housing as a watch component. A watch in which austenitization treatment using nitrogen gas is applied to the housing is disclosed in JP-A-2013-101157. Thereby, austenitizing a surface layer of ferritic stainless steel with nitrogen provides the required hardness, corrosion resistance as a housing for a watch.

However, in a watch component of JP-A-2013-101157, decoration of the front surface is not considered. In addition to the hardness and corrosion resistance, designed front surface decoration has been required for a watch component such as a housing.

### SUMMARY

A watch component includes austenitized ferritic stainless steel including a base composed of a ferrite phase, a surface layer composed of an austenitized phase, and a mixed layer formed between the base and the surface layer, the ferrite phase and the austenitized phase being mixed with each other, wherein the surface layer includes a mirror surface and a streak, and Sa_m/Sa is 0.01 to 0.2 and Sa/Sz is 0.03 to 0.1, where average roughness of the mirror surface is Sa_m, average roughness of the streak is Sa, and maximum roughness is Sz.

A watch includes the watch component described above.

### BRIEF DESCRIPTION OF THE DRAWINGS

FIG. 1 is a schematic plan view illustrating a configuration of a watch according to a first embodiment.

FIG. 2 is a schematic view illustrating appearance of a front surface of an outer case.

FIG. 3 is a schematic side sectional view illustrating a sectional structure of the outer case.

FIG. 4 is a diagram for describing the relationship between front surface roughness of a streak and appearance.

FIG. 5 is a diagram for describing the relationship between front surface roughness of a mirror surface and the front surface roughness of the streak, and appearance.

FIG. 6 is a flow chart of a method of manufacturing the outer case.

### DESCRIPTION OF EXEMPLARY EMBODIMENTS

### First Embodiment

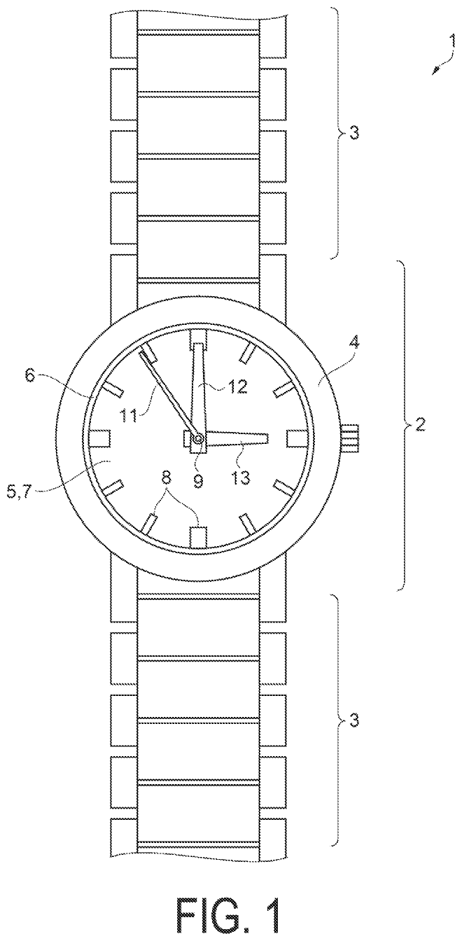

As illustrated in FIG. 1, a watch 1 includes a watch body 2. A watch strap 3 as a watch component coupled to the watch body 2 is arranged on an upper side and a lower side of the watch body 2 in the drawing. The watch strap 3 is wrapped around a human arm.

The watch 1 includes an outer case 4 as a cylindrical watch component. A cover glass 5 is arranged on one end of the outer case 4 along the cylindrical axis. A glass edge 6 as a watch component is arranged on the outer periphery of the cover glass 5. A side at which the cover glass 5 is arranged in the watch main body 2 is the front side. A circular flat plate-like dial 7 is arranged on the back surface side of the cover glass 5. An indicator 8 is arranged on the front side of the dial 7.

A hand shaft 9 is arranged at the center of the dial 7 in plan view of the dial 7. Attached to the hand shaft 9 is a seconds hand 11, a minute hand 12, and a hour hand 13. The hand shaft 9 includes three rotary shafts to which the seconds hand 11, the minute hand 12, and the hour hand 13 are attached.

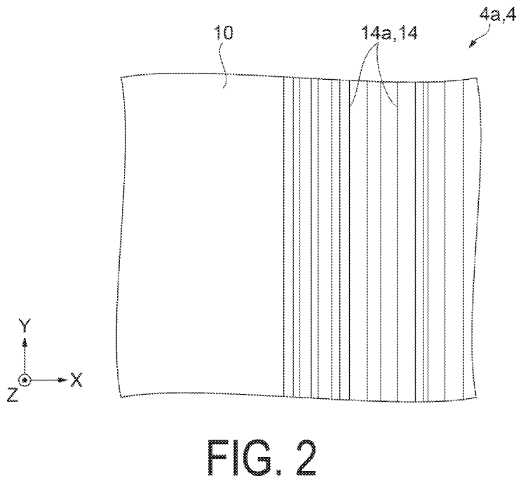

As illustrated in FIG. 2, a pattern in which streaks 14a are arranged substantially in parallel is referred to as a streak pattern. A surface at which the streak pattern is formed is referred to as a streak installation surface 14. A mirror surface 10 and the streak installation surface 14 are formed at a front surface 4a of the outer case 4. A spacing between adjacent streaks 14a is random. A normal line direction of the front surface 4a is referred to as the Z direction. A direction orthogonal to the Z direction and orthogonal to the streaks 14a is referred to as the X direction. A direction orthogonal to the X direction and the Z direction is referred to as the Y direction. The mirror surface 10 is a surface having small front surface roughness.

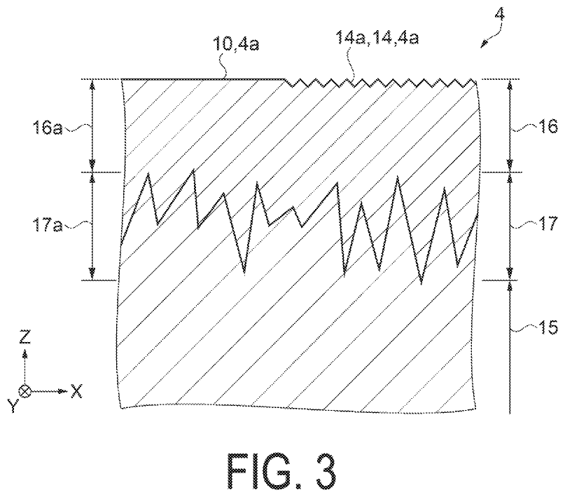

As illustrated in FIG. 3, the outer case 4 includes

a base 15 composed of a ferrite phase,

a surface layer 16 composed of an austenitized phase formed at the front surface 4a side of the base 15, and

a mixed layer 17 in which the ferrite phase and the austenizated phase are mixed with each other. The mixed layer 17 is formed between the base 15 and the surface layer 16. The outer case 4 is composed of austenitized ferritic stainless steel. The surface layer 16 has the mirror surface 10 and the streaks 14a.

According to this configuration, the front surface 4a of the outer case 4 is composed of an austenitized phase that is solid-solved and hardened with nitrogen, and therefore, the front surface is hard and difficult to be scratched. Since the inner surface of the outer case 4 is a ferrite phase, it can have anti-magnetic properties.

The hardness of the surface layer 16 is 350 Hv or greater and 400 Hv or less. The surface layer 16 is harder than, for example, the hardness of SUS316L, which is corrosion-resistant stainless steel, from 180 Hv to 220 Hv. According to this configuration, since the surface layer 16 has a high hardness, the surface layer 16 can be hard to be scratched, so that the mirror surface 10 and the streaks 14a are hard to deteriorate.

The base 15 is composed of ferritic stainless steel that contains, by mass, Cr: 18 to 22%, Mo: 1.3 to 2.8%, Nb: 0.05 to 0.50%, Cu: 0.1 to 0.8%, Ni: less than 0.5%, Mn: less than 0.8%, Si: less than 0.5%, P: less than 0.10%, S: less than 0.05%, N: less than 0.05%, and C: less than 0.05%, with the balance thereof consisting of Fe and unavoidable impurities.

In the nitrogen absorption treatment, Cr, Mo and Nb are elements that increase the nitrogen transfer rate to the ferrite phase and the nitrogen diffusion rate in the ferrite phase. In the nitrogen absorption treatment, Cu is an element that controls the nitrogen absorption in the ferrite phase. In the nitrogen absorption treatment, Ni, Mn, Si, P, S, N and C are elements that inhibit the nitrogen transfer to the ferrite phase and the nitrogen diffusion in the ferrite phase.

In the present embodiment, for example, the base 15 is formed using a metal consisting of ferritic stainless steel that contains Cr: 20%, Mo: 2.1%, Nb: 0.2%, Cu: 0.1%, Ni: 0.05%, Mn: 0.5%, Si: 0.3%, P: 0.03%, S: 0.01%, N: 0.01%, C: 0.02%, with the balance thereof consisting of Fe and unavoidable impurities.

The surface layer 16 is formed by subjecting the front surface of the base 15 with the nitrogen absorption treatment. The nitrogen concentration of the surface layer 16 is 1 wt % or greater and 1.6 wt % or less. According to this configuration, the nitrogen concentration of the surface layer 16 is 1 wt % or greater and 1.6 wt % or less, so that the hardness of the surface layer 16 can be 350 Hv or greater and 400 Hv or less.

In the process of forming the surface layer 16, the mixed layer 17 is caused by variation in the transfer rate of the nitrogen entering the base 15 consisting of the ferrite phase. In other words, at the location where the nitrogen transfer rate is high, the nitrogen enters into the deep part of the base 15 then to be austenitized, while at the location where the nitrogen transfer rate is low, the austenitization occurs only at the shallow part of the base 15. Therefore, the mixing layer 17 is formed in which the ferrite phase and the austenitized phase are mixed with each other with respect to the depth direction.

In a cross-sectional view in which the outer case 4 is cut from the front surface 4a in the depth direction, that is, in a cross section cut in a direction orthogonal to the front surface 4a, the surface layer 16 and the mixed layer 17 are formed such that a mixed layer thickness 17a, which is the thickness of the mixed layer 17, is 45% or less relative to a surface layer thickness 16a, which is the thickness of the surface layer 16. When the mixed layer thickness 17a/surface layer thickness 16a is 45% or less, that is, when the mixed layer thickness 17a is 45% or less relative to the surface layer thickness 16a, 85G or greater can be generally ensured, which can guarantee the anti-magnetic performance of the first class magnetic resistant watch.

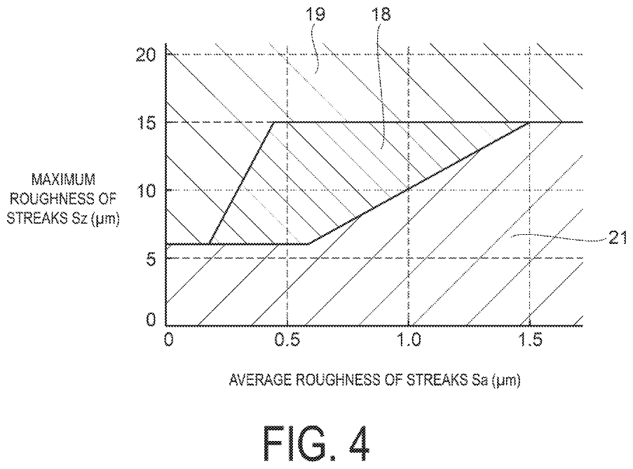

The horizontal axis in FIG. 4 illustrates average roughness Sa of the streaks 14a. The average roughness Sa of the streaks 14a illustrates an average of the absolute value of the difference in height of each point of the streaks 14a relative to the average surface of the front surface 4a. The longitudinal axis illustrates maximum roughness Sz of the streaks 14a. The maximum roughness Sz of the streaks 14a indicates the distance from the highest point to the lowest point of the streaks 14a. The measurement range is not particularly limited, but in the present embodiment is performed at 1.35 mm×1.0 mm.

The appearance of the streak installation surface 14 with respect to the average roughness Sa and the maximum roughness Sz can be divided into three regions. In a first region 18, the maximum roughness Sz is 6 μm or greater and 15 μm or less. The average roughness Sa/maximum roughness Sz is 0.03 or greater and 0.1 or less. In the outer case 4, the streak installation surface 14 is the front surface roughness illustrated in the first region 18. Since the streaks the streak pattern appears uniform in the first region 18, the streak installation surface 14 has a highly designed appearance.

In a second region 19, the maximum roughness Sz is greater than 15 μm. Alternatively, in the second region 19, the maximum roughness Sz is 6 μm or greater, and the average roughness Sa/maximum roughness Sz is less than 0.03. Since the front surface roughness of the second region 19 is too high, the streak installation surface 14 is strongly diffusely reflected into a glaring appearance. In the second region 19, light may be scattered and a multi-color stripe pattern may be visible.

In a third region 21, the maximum roughness Sz is less than 6 μm. Alternatively, in the third region 21, the maximum roughness Sz is 15 μm or less, and the average roughness Sa/maximum roughness Sz is greater than 0.1. In the third region 21, the streaks 14a are shallow and, therefore, the appearance of the streaks 14a is not visible.

When the maximum roughness Sz of the streaks 14a is less than 6 μm, the streaks 14a are not visible since the streaks 14a are shallow. When the maximum roughness Sz of the streaks 14a is greater than 15 μm, the streaks 14a are strongly diffusely reflected into a glaring appearance. According to this configuration, since Sz is 6 μm or greater and 15 μm or less, the outer case 4 has glossiness, and the outer case 4 can appropriately diffusely reflect light and have a highly designed appearance.

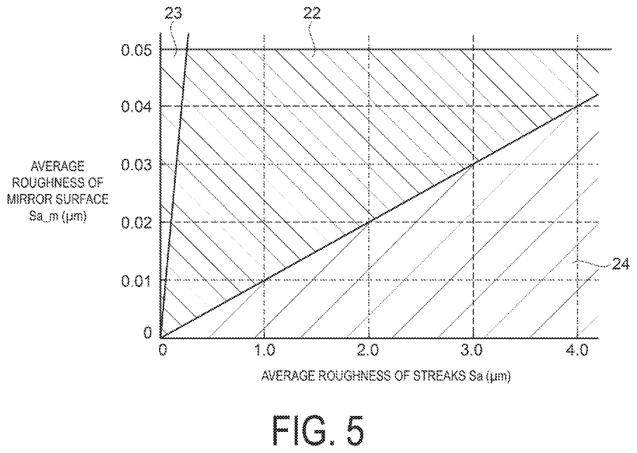

The horizontal axis in FIG. 5 illustrates average roughness Sa of the streaks 14a. The vertical axis indicates the average roughness Sa_m of the mirror surface 10. The appearance of the mirror surface 10 and the streaks 14a with respect to the average roughness Sa of the streaks 14a and the average roughness Sa_m of the mirror surface 10 can be divided into three regions. The average roughness Sa_m of the mirror surface 10 is not particularly limited, but is often from 0.02 μm to 0.04 μm, and is preferably smaller than 0.05 μm. In a fourth region 22, the average roughness Sa of the mirror surface 10 Sa_m/the average roughness Sa of the streaks 14a is 0.01 or greater and 0.2 or less. In the outer case 4, the mirror surface 10 and the streak installation surface 14 are related to the front surface roughness illustrated in the fourth region 22. In the fourth region 22, the mirror surface 10 and the streaks 14a are differentially identified, so that the streaks 14a have a highly designed appearance.

In a fifth region 23, the average roughness Sa of the mirror surface 10 Sa_m/the average roughness Sa of the streaks 14a is greater than 0.2. When the ratio of the average roughness Sa_m of the mirror surface 10 with respect to the average roughness Sa of the streaks 14a is greater than 0.2, the streaks 14a are shallow, so that the difference in appearance between the mirror surface 10 and the streaks 14a is small.

In a sixth region 24, the average roughness Sa of the mirror surface 10 Sa_m/the average roughness Sa of the streaks 14a is less than 0.01. When the ratio of the average roughness Sa_m of the mirror surface 10 with respect to the average roughness Sa of the streaks 14a is less than 0.01, the streaks 14a are too deep, so that the light is diffusely reflected into a glaring appearance. Furthermore, the processing time of the streaks 14a is increased, which results in the reduced productivity.

In the outer case 4, the average roughness Sa of the mirror surface 10 Sa_m/the average roughness Sa of the streaks 14a is 0.01 or greater and 0.2 or less. Furthermore, the average roughness Sa with respect to the maximum roughness Sz of the streaks 14a is 0.03 or greater and 0.1 or less. At this time, the streaks 14a has glossiness, and the streaks 14a can appropriately diffusely reflect light and have a highly designed appearance.

According to this configuration, the outer case 4 provided by the watch 1 has an designed appearance in which the front surface 4a is difficult to be scratched. Therefore, the watch 1 can include the outer case 4 having an designed appearance in which the front surface 4a is difficult to be scratched.

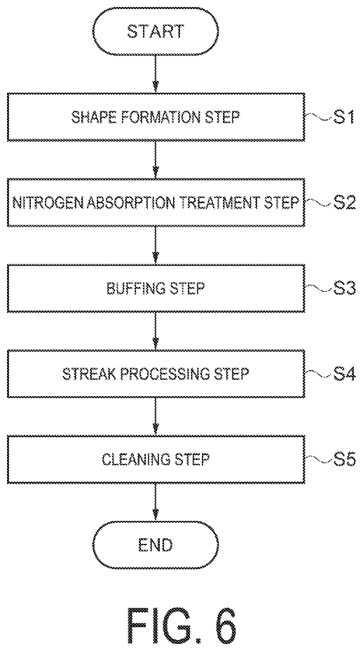

Then, a manufacturing method of the outer case 4 described above will be described in FIG. 6. In the flowchart of FIG. 6, step S1 is a shape formation step. In this step, a member having the ferrite phase is forged to form the shape of the outer case 4. The member that is a raw material is sandwiched by a mold and pressed by a pressing machine and deformed. In addition, the member having the ferrite phase may be cut by a milling machine to form the shape of the outer case 4. Next, the process proceeds to step S2.

Step S2 is a nitrogen absorption treatment step. In this step, the outer case 4 is subjected to the nitrogen absorption treatment. In the nitrogen absorption treatment, a nitrogen absorption processing device is provided that includes a treatment chamber surrounded by an insulating material such as glass fibers, a heating means for heating the treatment chamber, a pressure reducing means for reducing the pressure inside the treatment chamber, and a nitrogen gas introduction means for introducing nitrogen gas into the treatment chamber. Next, the outer case 4 is installed in the treatment chamber of the nitrogen absorption processing device, and then the pressure inside the treatment chamber is reduced to 2 Pa by the pressure reducing means.

Next, the nitrogen gas introduction means introduces the nitrogen gas into the treatment chamber while the pressure reducing means performs exhaust in the treatment chamber. The pressure in the treatment chamber is held from 0.08 to 0.12 MPa. In this state, the heating means raises the temperature in the treatment chamber to 1200° C. at a rate of 5° C./min.

The temperature of 1200° C. is maintained for 4.0 hours, which is the treatment time required for the surface layer thickness 16a to be 450 μm. Note that the aforementioned treatment time, 4.0 hours, is determined by a pre-test.

Thereafter, the outer case 4 is quenched by water cooling. As a result, the surface layer 16 including the austenitized phase is formed at the front surface 4a side of the base 15, and the mixed layer 17 in which the austenitized phase and the ferrite phase are mixed with each other is formed between the base 15 and the surface layer 16. Next, the process proceeds to step S3.

Step S3 is a buffing step. In this step, buffing is applied to the front surface 4a of the outer case 4. The motor rotates the buffing containing an alumina abrasive and an operator presses the outer case 4 against the buffing. The buffing is a special cotton fabric for polishing. The outer case 4 is polished to form the mirror surface 10. A pink buff for jewelry is used for the buffing. Next, the process proceeds to step S4.

Step S4 is a streak processing step. In this step, a number of streaks 14a are formed in a portion of the mirror surface 10. In this step, an endless machine is used. The endless machine rotates the ring-like abrasive belt. While applying the alumina abrasive to an abrasive fabric belt, the operator presses the outer case 4 against the abrasive fabric belt. For example, the No. 240 alumina abrasive is used. The operator controls the pressing force to bring the front surface roughness of the outer case 4 into the first region 18 and the fourth region 22. When the pressing force is too high, the roughness becomes the state of the second region 19 and the sixth region 24. When the pressing force is low, the roughness becomes the state of the third region 21 and the fifth region 23. Next, the process proceeds to step S5.

Step S5 is a cleaning step. In this step, the alumina abrasive and dust adhering to the outer case 4 are removed. The streak installation surface 14 is formed at the front surface 4a of the outer case 4 by the steps described above. According to the method described above, the outer case 4 can be provided that has glossiness on the front surface 4a that is solid-solved and hardened with nitrogen, and has the designed streak installation surface 14 in which the streaks 14a reflect light appropriately diffusely.

### Second Embodiment

In the first embodiment, the streak installation surface 14 is formed at the outer case 4. The watch component at which the streak installation surface 14 is formed may be applied to the glass edge 6, the watch strap 3, the crown, and the case back.

### Third Embodiment

In the first embodiment, the maximum roughness Sz of the streaks 14a is 6 μm or greater and 15 μm or less. The average roughness Sa of the mirror surface 10 Sa_m/the average roughness Sa of the streaks 14a is 0.01 or greater and 0.2 or less, and Sa/Sz is limited to 0.03 or greater and 0.1 or less. At this time, the maximum roughness Sz of the streaks 14a may be less than 6 μm due to the palatability of the appearance. The maximum roughness Sz of the streaks 14a may be greater than 15 μm.

1. A watch component comprising austenitized ferritic stainless steel including
a base composed of a ferrite phase,
a surface layer composed of an austenitized phase, and
a mixed layer formed between the base and the surface layer, the mixed layer including the ferrite phase and the austenitized phase mixed with each other, wherein
the surface layer includes a mirror surface and a streak, and
Sa_m/Sa is 0.01 to 0.2 and Sa/Sz is 0.03 to 0.1 where average roughness of the mirror surface is Sa_m, average roughness of the streak is Sa, and maximum roughness is Sz.

2. The watch component according to claim 1, wherein Sz is 6 μm to 15 μm.

3. The watch component according to claim 1, wherein hardness of the surface layer is 350 Hv to 400 Hv.

4. The watch component according to claim 2, wherein hardness of the surface layer is 350 Hv to 400 Hv.

5. The watch component according to claim 3, wherein a nitrogen concentration of the surface layer is 1 wt % to 1.6 wt %.

6. The watch component according to claim 4, wherein a nitrogen concentration of the surface layer is 1 wt % to 1.6 wt %.

7. A watch comprising the watch component according to claim 1.

8. A watch comprising the watch component according to claim 2.

9. A watch comprising the watch component according to claim 3.

10. A watch comprising the watch component according to claim 4.

11. A watch comprising the watch component according to claim 5.

12. A watch comprising the watch component according to claim 6.
